(19) United States
(12) Patent Application Publication
(10) Pub. No.: US 2003/0172376 A1
(43) Pub. Date: Sep. 11, 2003

(54) User controlled targeted advertisement placement for receiver modules

(75) Inventor: Louis F. Coffin III, Mountain View, CA (US)

Correspondence Address: RICK D. NYDEGGER, WORKMAN, NYDEGGER & SEELEY, 1000 Eagle Gate Tower, 60 East South Temple, Salt Lake City, UT, 84111, US

(73) Assignee: Microsoft Corporation

(21) Appl. No.: 10/096,022

(22) Filed: Mar. 11, 2002

(51) Int. Cl. G06F 17/60; H04N 7/16; H04H 9/00

(52) U.S. Cl. 725/22; 725/23; 705/14

(57) ABSTRACT

Systems and methods for displaying broadcast programming and generating points for viewing advertising content selected by the viewer. The systems and methods store one or more viewer attributes unique to the viewer. These attributes define one or more categories of advertising content to be displayed to the viewer and the points earned from viewing displayed advertising content. The viewer defines one or more categories of advertising to be displayed and the methods and systems select advertising content, either via a operator module delivering or the receiver module receiving the advertising content, having a category identifier matching the category selected by the viewer. This advertising content is displayed to the viewer and the viewer's points are updated to reflect that the viewer watched all or a portion of the advertising content.

### BACKGROUND OF THE INVENTION

1. The Field of the Invention

The present invention generally relates to providing advertising content to a viewer of a display device capable of displaying broadcast programming. More specifically, the present invention broadly relates to enabling a viewer to select advertising content and obtain discounts or subsidies based upon the particular advertising content viewed.

2. Background and Related Art

For numerous years, homes, offices, and other buildings have accessed television programming through airwave broadcasts, cable providers, satellite transmission, and other communication channels. Television provides viewers with a varied assortment of entertainment, news, and educational programming. From the first broadcasts to current television programming, viewers gather a wealth of knowledge while being entertained.

In addition to the above, televisions provide a medium through which individuals, businesses, political parties, or the like can solicit individuals to purchase products or services. Advertisements provide a viewer with information of the availability of new products, new purchase rates, and other information specific to different products. Additionally, advertisements, whether static banner advertisements displayed on an electronic program guide or video advertisements typically displayed during a broadcast programming event, generate goodwill and product recognition for the company's products or services.

Providers of these advertisements desire to maximize revenue by enticing the viewer to purchase the product or services offered by the provider. While such advertising may sometimes seem bothersome to viewers, the presence of advertising often reduces the cost of the desired services offered by the service provider. For example, many television channels are free, since revenue from advertising alone is sufficient to provide the television channels. Other the other hand, some premium channels present no advertisements, but instead achieve adequate incentives for providing the channel by charging the viewers a periodic fee.

With recent advances in technology, however, viewers can select to “skip” advertisements that are displayed in association with conventional broadcast programming. More specifically, a viewer that identifies an advertisement as being bothersome is able to “skip” the advertisement and continue to watch the associated broadcast programming event. This ability for viewers to “skip” advertisements may lead to a reduction in the cost-per-timeslot that broadcast program providers are able to obtain from advertisers. Additionally, with such advertisement slots becoming, potentially, less desirable and effective, advertisers may choose to use other media to promote the products and services.

### BRIEF SUMMARY OF THE INVENTION

To overcome the existing problems associated with the current manners for delivering broadcast programming and advertising content to the viewers or subscribers of a cable or satellite broadcast programming system, disclosed herein are systems and methods for enabling a viewer to select particular advertising content to be displayed to the viewer based upon the viewer's personal interests. Further, to overcome the existing limitations associated with the costs associated with subscribing to broadcast programming, disclosed herein are systems and methods for enabling a viewer to generate a “pool” of rewards that can be used to offset or eliminate the costs associated with viewing pay-per-view programming, subscribing to premium channels, paying monthly activation fees, or the like. In this manner, viewers are incentivized to watch displayed advertising content because such advertising content is selected by the viewer.

According to one embodiment of the present invention, the systems and methods enable a viewer to select one or more categories of advertising content to be displayed to the viewer. Consequently, the viewer defines which advertising content the viewer wishes to view. By so doing, the available advertising content is filtered, either at the head end or receiver side, to identify and subsequently display to the viewer only advertising content that matches the categories of advertising content selected by the viewer. In other embodiments of the present invention, the majority of the advertising content displayed to the viewer is related to one or more of the categories of advertising content selected by the viewer, while the remaining displayed advertising content is selected by the cable or satellite provider.

As the viewer watches the advertising content, embodiments of the present invention optionally tracks the actions of the viewer. For example, illustrative methods and systems of one embodiment of the present invention track whether the viewer skips or prematurely terminates displayed advertising content. Additionally, illustrative methods and systems identify when the advertising content is completely displayed to the viewer. Further, the illustrative methods and systems track when a viewer purchases goods or services displayed in the advertising content. These tracked actions are translated into variations in the number or quantity of rewards that the viewer can earn from watching the displayed advertising content. Since the viewer obtains a personal benefit from generating a number or quantity of rewards from viewing advertising content, whether selected by the viewer or included with the broadcast programming, the viewer is incentivized to view the displayed advertising content.

According to one illustrative embodiment, when the viewer completely watches an advertisement, the methods and systems of the present invention update a stored rewards earned attribute that defines the “pool” or number of rewards earned by the viewer. Consequently, the viewer gains one or more rewards for completely viewing the advertising content, i.e., one advertisement. Alternatively, the stored rewards earned attribute can be updated based upon the number of minutes, seconds, or the like of advertising content watched by the viewer. For example, by watching thirty seconds of advertising content, the viewer's rewards are increased by a number of rewards associated with viewing thirty seconds of advertising content.

In addition to the above, the viewer can earn rewards or increase the viewer's number of rewards or points, i.e., pool, by purchasing goods or services associated with the displayed advertising content. Embodiments of the present invention enable the viewer to select to purchase goods or services displayed within the advertising content. Consequently, the viewer can select to purchase goods or services as he/she watches the advertising content or following watching the advertising content. The purchase of such goods or services is translated into an associated number of rewards; thereby increasing the viewer's “pool.”

Alternatively, the viewer can select to purchase goods or services advertised through the advertising content and subsequently receive the goods or services upon going to a “brick and mortar” business. When the viewer selects to purchase a displayed good or service, embodiments of the present invention display a purchase code for that good or service and optionally that viewer. Upon the viewer “physically” purchasing the goods or services at the “brick and mortar” business, he/she can present the purchase code to receive viewer specific discounts or identify that the viewer is making the purchase subsequent to viewing advertising content related to the good or service. Subsequently, the business can notify the cable or satellite provider of the purchase, thereby enabling the cable or satellite provider to update the viewer's earned rewards. Again, the viewer of advertising content achieves a benefit from watching the available advertising content through receiving the purchase code, resulting in the viewer being incentivized to view the displayed advertising content.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only illustrative embodiments of the invention and are not therefore to be considered to be limiting of its scope, the invention will be described and explained with additional specificity and detail through the use of the accompanying drawings in which:

FIG. 1 illustrates an exemplary system of the present invention;.

FIG. 2 illustrates a schematic representation of an exemplary operator module of the present invention;

FIG. 3 illustrates a schematic representation of an exemplary embodiment of a receiver module of the system of FIG. 2;

FIG. 4 illustrates a schematic representation of one or more viewer accounts and stored attributes within one or more of the viewer accounts stored in the exemplary system of FIG. 2;

FIG. 5 illustrates a schematic representation of the selections made by the viewer to define categories of advertising content to be displayed to the viewer through use of the system of FIG. 2;

FIG. 6 illustrates a flow diagram representation of an exemplary method to select one or more categories of advertising content to be displayed to the viewer through use of the system of FIG. 2;

FIG. 7 illustrates a schematic representation of the manner by which advertising content associated with an advertising content category selected by the viewer is substituted for advertising content associated with broadcast programming delivered through use of the system of FIG. 2;

FIG. 8 illustrates a schematic representation of the advertising content displayed to the viewer through use of the system of FIG. 2; and

FIG. 9 illustrates a flow diagram representation of the method by which broadcast programming and advertising content are displayed to the viewer through use of the system of FIG. 2.

### DETAILED DESCRIPTION OF THE PREFERRED EMBODIMENTS

The present invention enables viewers to select categories of advertising content to be displayed to the viewer. The advertising content associated with the selected categories is substituted for general advertising content scheduled to be displayed with the broadcast programming deliverable to the viewer. Consequently, embodiments of the present invention extend to systems and methods for substituting the advertising content displayed with broadcast programming with advertising content selected by the viewer. In this manner, the embodiments of the present invention incentivise the viewer to watch advertising content, with the knowledge that such advertising content relates to the viewer's interests.

According to another aspect of the present invention, illustrative systems and methods enable the viewer to generate a “pool” of rewards or points that offset or eliminate the costs associated with viewing pay-per-view programming, subscribing to premium channels, paying monthly activation fees, or the like. Each time the viewer completely or partially watches displayed advertising content, illustratively, the viewer earns rewards or points that can be redeemed for viewer specific discounts, subsidies, or the like. Therefore, the viewer obtains a benefit from watching advertising content presented to the viewer during a break in the displayed programming. Through providing rewards to the viewer, the viewer is incentivized to view the advertising content rather than skipping or fast forwarding SOOF through the displayed advertising content, such as is possible in digital video recorder (DVR) or personal video recorder (PVR) environments.

According to another aspect of the present invention, illustrative systems and methods are provided to enable a viewer to elect to purchase products and/or services advertised through the advertising content selected by the viewer. By purchasing the products or services advertised by the advertising content, a viewer can generate a “pool” of earned rewards or points that can be used to offset the costs associated with watching broadcast programming, watching pay-per-view movies or events, or the like. Further, a viewer can access special offers available to those viewers that purchase products or services during or following the display of related advertising content selected by the viewer.

Again, the viewer is incentivized to view broadcast programming, watch advertising content selected specifically by the viewer, and purchase products and services related to such advertising content. Consequently, the viewer is incentivized to participate to a greater degree with broadcast programming and advertising content, while the inclination of the viewer to skip or fast forward displayed advertising content, such as in a DVR or PVR environment, is reduced. Therefore, the effectiveness of advertising content is increased and the revenue per advertising content time slot available to a broadcast programming provider can be increased.

For purposes of this description and in the claims, the term “programming” includes the viewable portions of moving image data and its associated sound data, deliverable from a single channel source or from a multi-channel source. Similarly, the term “advertising content” includes both the viewable portions of moving image data and its associated sound data, whether delivered from a single channel source or a multi-channel source.

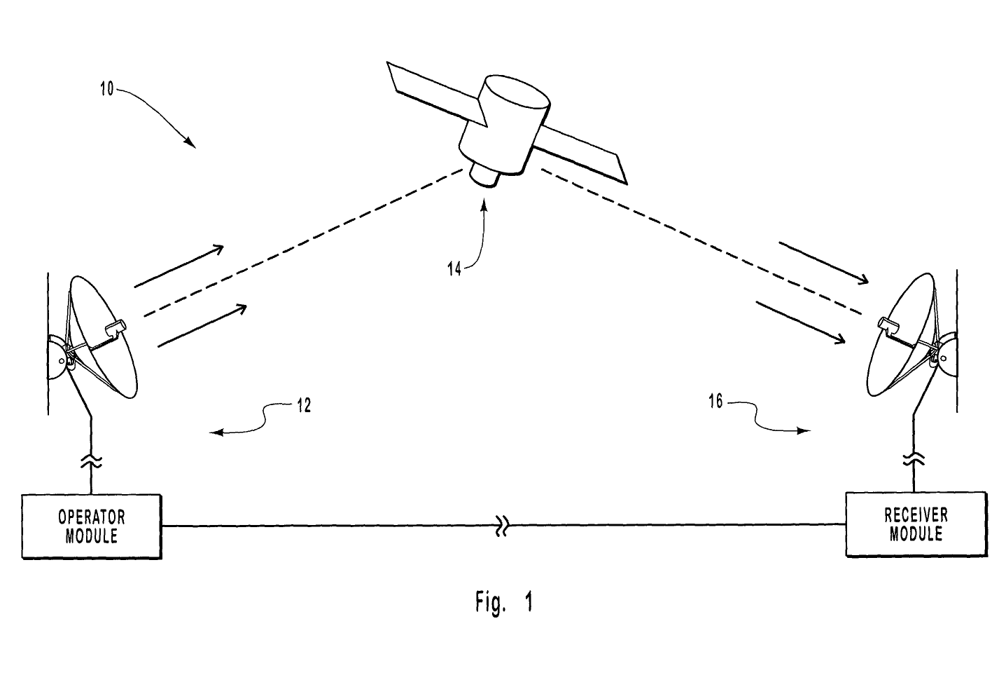

Referring now to FIG. 1, depicted is a schematic representation of one illustrative system of the present invention. The illustrative configuration will be described in the environment of a satellite system where broadcast programming, including advertising content, is delivered between terrestrial stations via an intermediate celestial station, i.e., a satellite. Although reference is made to individual terrestrial and celestial stations, one skilled in the art can understand that alternate systems can utilize one or more terrestrial and celestial stations.

As shown, system 10 includes an operator module 12 that communicates with a receiver module 16 via a satellite 14. The operator module 12 can retrieve or receive the broadcast programming and/or advertising content from one or more other stations associated with international, national, or local broadcast programming and advertising content providers, such as but not limited to, NBC, ABC, CBS, FOX, or the like (termed individually as a “Network” and collectively as the “Networks”). The operator module 12 stores the broadcast programming and advertising content for delivery to receiver module 16 and subsequent display to a viewer.

The broadcast programming and advertising content can be stored in a variety of forms within operator module 12. In one configuration, operator module 12 stores the broadcast programming and advertising content on separate storage media. For instance, the advertising content can be stored on one storage medium as an advertising content carousel that delivers requested advertising content “on-demand” from internal modules of operator module 12 or based upon display times of the advertising content, while the broadcast programming is stored as indexed files on another storage medium. In another configuration, the advertising content is stored as an indexed list of advertising content, where indexing is based upon one or more attributes of the advertising content. For instance, an attribute may be a category type of the advertising content, i.e., advertising for viewers meeting specific demographic indicators such as age, gender, geographic location, educational level, income level, etc, entertainment related advertising content, travel related advertising content, purchasable goods or services related advertising content, or the like.

In another configuration, operator module 12 stores the broadcast programming and advertising content in a single storage medium as two separately indexed lists of files or data, whether or not such indexed lists are cross-linked. In still another configuration, operator module 12 stores the broadcast programming and advertising content in a single indexed list of files.

In other embodiments or configurations of the present invention, broadcast programming and/or advertising content can be stored in calendar period groupings, where advertising content and/or broadcast programming to be displayed during the same day, week, month, etc are indexed together. Generally, therefore, broadcast programming and advertising content can be stored in any manner known to one skilled in the art, and in any format known to one skilled in the art, so long as the broadcast programming and advertising content are accessible for delivery to receiver module 16. For instance, the broadcast programming and/or the advertising content can be in a Windows Media Player format, a compressed MPEG format, or the like.

Various types of storage media can be used to store the broadcast programming and advertising content, whether separately or collectively. The storage medium is one structure capable of performing the function of a computer-readable medium for carrying or having computer-executable instructions or data structures stored thereon. This computer-readable medium can be any available media that can be accessed by a general purpose or special purpose computer. By way of example, and not limitation, such computer-readable media can include physical storage media such as RAM, ROM, EEPROM, CD-ROM or other optical disk storage, magnetic disk storage or other magnetic storage devices, modular or fixed memory, or any other medium that can be used to carry or store desired program code means in the form of computer-executable instructions or data structures and that can be accessed by a general purpose or special purpose computer.

In addition to storing the broadcast programming and the advertising content, operator module 12 can store data indicative of when the advertising content is to be displayed with the broadcast programming. For instance, operator module 12 can include an advertising content table populated with information specific to the available advertising content, such as advertising content title, display duration of the advertising content, display time of the advertising content, reward points earned from viewing the advertising content, associated broadcast programming, if any, or the like. This information can be delivered to receiver module 16 from operator module 12.

Instead of using a table to store the advertising content information, a database having a hierarchal, relational, flat, or other database structure can store the information. In this case, the information is populated into a file that is deliverable to receiver module 16.

In addition to storing broadcast programming and advertising content, operator module 12 can store information about each viewer that utilizes receiver module 16 to view the broadcast programming and advertising content. For example, operator module 12 can store information or data about viewer accounts, viewing preferences, advertising content viewed, purchases made based upon advertising content watched, rewards or points earned, purchase codes, or the like.

This information can also be stored in an accessible database having hierarchal, relational, flat, or other database structure. Such database can utilize various types of storage media, such as but not limited to, the types of storage media described herein. Greater information about operator module 12 will be described hereinafter.

In communication with operator module 12 is receiver module 16. Receiver module 16 can receive broadcast programming and advertising content via satellite 14. Although reference is made to communication or delivery of broadcast programming and advertising content to receiver module via satellite 14, it can be understood that operator module 12 can deliver broadcast programming and advertising content via a number of different communication connections. For example, operator module 12 can deliver broadcast programming and advertising content via a cable system, a wireless system, or broadcast airways, a combinations thereof, or the like.

Receiver module 16 is configured to receive and store advertising content and present advertising content to the viewer in accordance with selections of a viewer utilizing receiver module 16. The receiver module 16 enables a viewer to select specific advertising content and/or one or more categories of advertising content to watch during the breaks in the displayed broadcast programming. For instance, in a typical system, an operator of operator module 12 defines which advertising content to display with which broadcasting programming. In embodiments of the present invention, however, the viewer can select which advertising content to view. More specifically, receiver module 16 provides a viewer with a graphical user interface through which the viewer can select the advertising content to be displayed to the viewer. This process of selecting advertising content to view can occur when the viewer selects a button of an input device, such as a remote control, in response to a prompt presented to the user on a display device. Alternatively, the process of selecting advertising content can occur upon selecting one of a number of menus accessible through use of the input device, separate from receiving a prompt to select viewable advertising content.

The selected advertising content, whether defined individual advertising content or categories of advertising content, can be displayed when the viewer accesses an electronic program guide (EPG), when the viewer initiates an interactive experience, during the commercial break in the display broadcast programming, or the like. The information defining the viewer's advertising content preferences can be stored at the receiver module 16 to facilitate identification of the desired advertising content from the available advertising content and also maintaining the privacy of the viewer's preferences.

In addition to selecting the type of advertising content to be displayed to a particular viewer, embodiments of receiver module 16 enable the viewer to select when to watch advertising content and/or broadcast programming. For example, receiver module 16 allows a viewer to select to watch advertising content, substitute displayed advertising content with advertising content selected by the viewer, or the like. Illustratively, the viewer can use an input device to select to “skip” displayed advertising content, resulting in receiver module 16 retrieving advertising content stored at receiver module 16 and displaying the same to the viewer through an appropriate display device.

Alternatively, embodiments of the present invention can be embodied in a receiver module that utilizes DVR or PVR technologies as known to those skilled in the art. Therefore, a viewer can utilize the DVR or PVR technologies to skip or fast forward past displayed advertising content and/or programming and subsequently watch viewer specific advertising content or broadcast programming.

In addition to enabling the viewer to select the advertising content he/she wishes to watch and/or skip, receiver module 16 is configured to track the viewer's actions as he/she watches the advertising content, skips the advertising content, fast forwards the advertising content, or the like. The receiver module 16, based upon tracking such actions, retrieves stored advertising content selected by the viewer, whether such advertising content is selected by the viewer through a category selection, through the viewer selecting the specific advertising content upon the viewer selecting to skip or fast forward past the displayed advertising content, combinations thereof, or the like.

Additionally, receiver module 16 can forward data indicative of the viewer's actions to operator module 12 to enable operator module 12 to store information about the actions of the viewer, thereby allowing operator module 12 to deliver more specific advertising content to receiver module 16 for the specific viewer. The communication between receiver module 16 and operator module 12 can be achieved via a terrestrial communication link, such as a plain old telephone system (POTS). Alternatively, receiver module 16 can deliver such data via a cable connection, a wireless connection, an asymmetric digital subscriber line (ADSL) connection, Integrated Services Digital Network (ISDN), Ethernet, or similar other connections known to those skilled in the art.

As receiver module 16 tracks the actions of the viewer, receiver module 16 identifies a number of rewards or points generated by the viewer, i.e., the “pool” of rewards or points generated by the viewer for watching the advertising content, skipping the advertising content, fast forwarding past the advertising content, or the like. As mentioned above, these rewards or points can be used to discount or subsidies for those costs or fees associated with leasing the hardware and/or software associated with receiver module 16 and/or watching particular fee-based programming.

Although reference is made herein to use of embodiments of the present invention with DVR and/or PVR devices and technologies, one skilled in the art can appreciate that other systems and devices can benefit from the teaching of the present invention. For instance, embodiments of the present invention can utilize any type of receiver module 16 that can store advertising content or access a store of advertising content, whether or not such receiver module includes the functionality of a DVR or PVR engine or technology.

Generally, system 10 can have various configurations so long as operator module 12 can communicate with receiver module 16 and operator module can deliver broadcast programming and advertisement content to receiver module 16.

One skilled in the art can identify various other configurations of system 10 to meet the above-defined functional requirements of system 10. For example, and not by way of limitation, system 10 can be a cable system where broadcast programming from operator module 12 is delivered directly to receiver module 16 via cable lines, whether such cable lines include typical conductor wire, wireless communication lines, optical fibers, combinations thereof, or the like. Additionally, alternate systems can allow bidirectional communication between operator module 12 and receiver module 16 to enable delivery of viewer preferences and data indicative of viewer actions to be delivered to operator module 12. In this manner, operator module 12 can analyze the viewer's preferences and actions to provide additional services, advertising content, or the like specific to the viewer. The communication between receiver module 16 and operator 12 can be achieved through one or more of the communication connections described herein or otherwise known to one skilled in the art.

The following discussion of system 10 will be described with respect to functional blocks that describe the various functions of the different elements, components or modules of system 10. It can be appreciated by one skilled in the art that the functional description should not be considered as limiting the types of hardware and/or software that may be used to perform the desired functions.

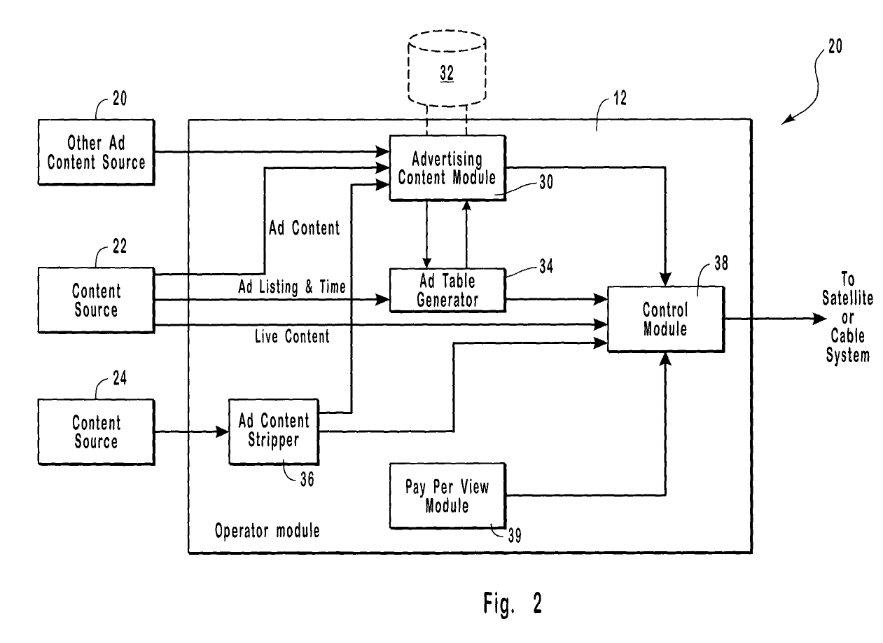

Referring now to FIG. 2, a generalized schematic representation of one embodiment of operator module 12 of the present invention is depicted. As illustrated, operator module 12 communications with various content sources and receives advertising content and broadcast programming from one or more of the same. As illustrated, operator module 12 receives advertising content from an ad content source 20, while receiving advertising content and broadcast programming from a content source 22 and a content source 24. Although reference is made to three sources 20, 22, 24, it can be appreciated by one skilled in the art that a greater or lesser number of broadcast programming and/or advertising content sources can interact with operator module 12.

Ad content source 20 represents any of a variety of sources for advertising content that are not associated with the Networks, cable provider, satellite provider, or the like. For instance, ad content source 20 can represent a private source of advertising content for specific organizations or entities, such as an advertising agency's database of advertising content. Consequently, operator module 12 can communicate through a communication linkage with ad content source 20 to retrieve advertising content to be displayed by receive module 16.

In contrast to ad content source 20, content sources 22 and 24 each represent a typical Network that provides broadcast programming and/or advertising content to operator module 12. Content source 22 is illustrated as delivering live broadcast programming on one Motion Picture Expert Group (MPEG) stream and advertising content, with associated advertising content listings and times, on another MPEG stream. Alternatively, as illustrated by content source 24, the advertising content and the broadcast programming can be mixed together and delivered to operator module 12 along a single MPEG stream.

Ad content source 20 illustratively delivers advertising content to an advertising content store 30 of operator module 12. The advertising content store 30 functions as a repository of the data associated with the advertising content that can be displayed to a viewer using receiver module 16. The advertising content store 30 can include a database of stored advertising content, whether such advertising content is video data, audio data, banner data, combinations thereof, or the like.

The advertising content store 30 can store the advertising content data within a database associated with advertising content store 30 or alternatively can access another database, designated by reference numeral 32, separate from advertising content store 30, whether or not such separation is physical or virtual. The database can be hierarchal, relational, flat, or other database structure and include a database management system known to those skilled in the art. Additionally, the database can utilize modular or fixed memory, magnetic disk storage, optically read storage, or other mass storage known to one skilled in the art for storing advertising content. Although a single database is illustrated, alternate embodiments of the present invention can utilize multiple or a plurality of databases.

The advertising content stored within the database associated with advertising content store 30 can be stored in a variety of manners. For example, the advertising content can be stored in a similar manner to operator module 12 storing the respective information and data, as described above. Illustratively, advertising content store 30 can store the advertising content in: (i) alphabetical order; (ii) category order, where advertising content directed to a particular grouping of advertising content is stored together; (iii) calendar order, where days, weeks, months, etc. of advertising content are stored together for delivery to receiver module 16; (iv) viewer selection order, (v) indexed list(s), whether or not the list(s) are cross linked, (vi) an automated advertising carousel that delivers advertising content to receiver module 16 continuously, periodically, sporadically, or upon receiving a a request from receiver module 16, or the like.

As shown in FIG. 2, operator module 12 includes an ad table generator 34 that prepares or generates a table or list of available advertising content. For instance, the table or list defines the available advertising content, the particular MPEG stream upon which the advertising content will be delivered to receiver module 16, the particular time when the advertising content will be delivered, the particular category with which the advertising content is associated, or the like. This ad table generator 34 can communicate with ad content store 30 to retrieve information or data about the advertising content, thereby enabling ad table generator 34 to prepare the table or list that is deliverable to receiver module 16.

In addition to ad table generator 34, operator module 12 includes an ad content stripper 36. As the name suggests, ad content stripper 36 separates the advertising content from broadcast programming that is received by operator module 12 from content source 24. Alternatively, ad content stripper 36 can separate the advertising content from the live broadcast programming delivered from content source 22. For example, ad stripper 36 can analyze the bit stream of the MPEG stream containing the broadcast programming and the advertising content to identify the beginning of the advertising content. As the MPEG stream is delivered to operator module 12, ad content stripper 36 removes the advertising content from the MPEG stream, stores the same in ad content store 30, and delivers the remaining broadcast programming to a control module 38. Alternatively, ad content stripper 36 makes a copy of the advertising content for storing in ad content store 30, while delivering the broadcast programming and the advertising content to control module 38.

The control module 38 is adapted to receive broadcast programming, advertising content, and advertising content tables or lists and periodically, sporadically, or continuously delivers the same to receiver module 16 through network 22. For instance, control module 38 is configured to receive broadcast programming and advertising content from content source 22 and ad content store 30, modulate the programming and content for delivery via satellite and/or cable communication medium, aggregate the data associated with the programming and content, and deliver the modulated and aggregated data along one or more MPEG streams to receiver module 16. Further, control module 38 is adapted to receive pay-per-view programming from a pay-per-view module 39 that stores “on-demand” or “pay-per-view programming that is available to the viewer at receiver module 16. Such a pay-per-view module 39 can obtain the programming from another data source or storage in a similar manner to advertising content module 30 obtaining advertising content from database 32 or can receive pay-per-view programming from another source.

In addition to delivering advertising content and broadcast programming to receiver module 16, control module 38 is configured to receive data indicative of the various actions of a viewer and subsequently store the same within control module 38 or within a mass storage accessible by control module 38. This data or information can be used by control module 38 to identify advertising content to be delivered to receiver module 16, the bonuses received by the viewers from generating rewards, subsidies available to the viewers due to the reward pool generated by the viewer, deductions to the costs for viewing broadcast programming, pay-per-movies, special events, or rental of the equipment associated with receiver module 16 based upon the advertising content viewed by the viewer, the pool, rewards or points generated by the viewer, or the like. Additionally, control module 38 is configured to deliver notices to receiver module 16 indicating the availability of any of the above, i.e., the size of the pool, the number of points or rewards earned, the availability of subsidies, or the like.

According to one embodiment of the present invention, and implied above, operator module 12 delivers broadcast programming and advertising content to receiver module 16 through network 22. Network 22 can represent a cable system network, a satellite system, a wireless system network, combinations thereof, POTS, PSTN, or the like.

Consequently, network 22 can represent, as depicted in FIG. 1, the satellite communication between operator module 12 and receiver module 16, while also representing the communication between receiver module 16 and operator module 12 directly along cable lines or telephone lines. Additionally, network 22 can be a local area network (LAN) or a wide area network (WAN), no matter the particular type of topology, protocol, or architecture used to form network 22 so long as network 22 allows or facilitates communication between receiver module 16 and operator module 12.

As illustrated, system 10 includes a receiver module 16. The receiver module 16 can represent either a single receiver or set top box or a combination of multiple receivers or set top boxes with associated management or controller type modules, whether or not such receiver modules are in one location or distributed throughout many location. Further, receiver module 16 can include one or more display devices for presenting programming and advertising content to a viewer.

Generally, receiver module 16 comprises a special purpose or general-purpose computer or special purpose processing device including various computer hardware and/or software known by one skilled in the art for receiving signals from a broadcast programming source or some other source for enhancing the capabilities of conventional televisions. Exemplary receiver module 16 include a cable television box, a digital video broadcasting system (“DVB”), some other type of digital satellite system receiver (“DSS”), a DVR, a PVR, another type of set top box with Internet capabilities, or the like.

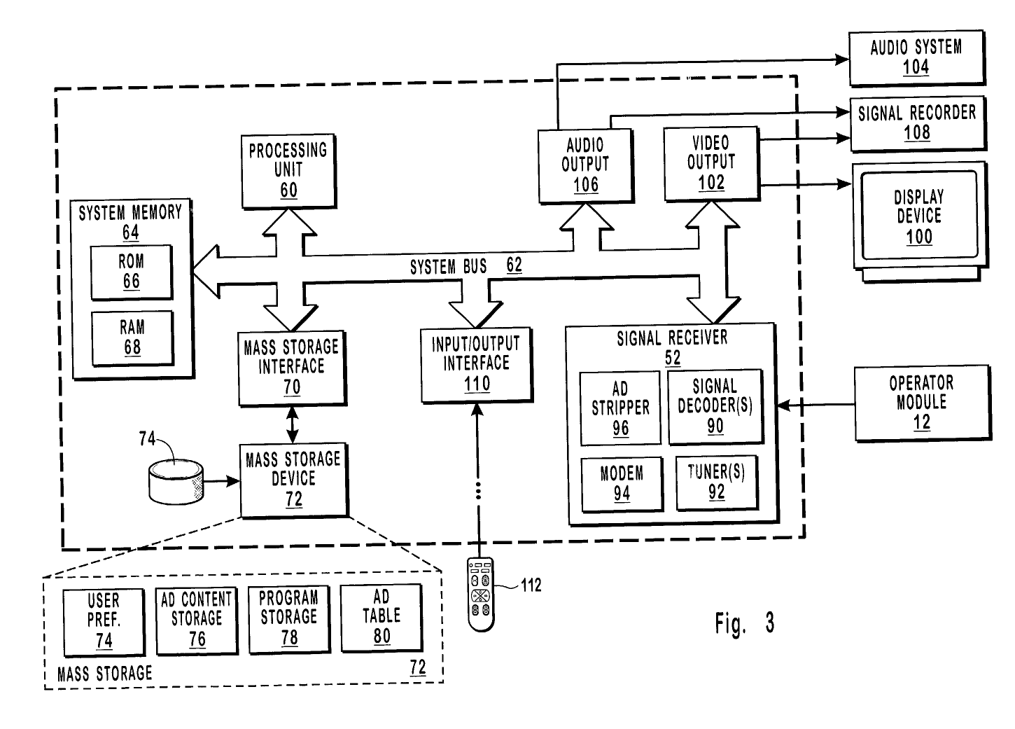

FIG. 3 illustrates a specific example of one of the many types of receiver modules that can be used with the invention. Receiver module 16, as illustrated, includes a central processing unit 60 that uses computer-executable instructions implemented in software and/or hardwired logic circuitry to perform various functions. These computer-executable instructions, such as operator modules, cause receiver module 16 to perform a certain function or group of functions.

Generally, operator modules can include routines, programs, objects, components, data structures, etc. that perform particular tasks or implement particular abstract data types. Computer-executable instructions, associated data structures, and operator modules represent examples of the program code means for executing steps of the methods disclosed herein. The particular sequence of such executable instructions or associated data structures represents examples of corresponding acts for implementing the functions described in such steps.

Processing unit 60 is coupled via a system bus 62, which also interconnects various other system components of receiver module 16. Processing unit 60 executes software designed to implement features of receiver module 16 including features of the present invention. Processing unit 60 can include circuitry that is used to implement certain functions of receiver module 16.

Instructions, data, and other software associated with the operation of processing unit 60 can be stored in a system memory 64, such as in read-only memory (“ROM”) 66 and/or in random-access memory (“RAM”) 68, and/or in a mass storage device 72, which is coupled to mass storage interface 70. The ROM 66, RAM 68 and mass storage device 72 are communicatively coupled to processing unit 60 so as to be readable by processing unit 60 and so that data may be written from processing unit 60 to RAM 68 and possibly mass storage device 72.

Mass storage device 72 may be a magnetic hard disk 74 or any other magnetic or optical mass memory device that is capable of storing data. Any desired computer-readable instructions or data, including application programs, other operator modules, and an electronic programming guide (“EPG”) can be stored in mass storage device 72. For instance, mass storage device 72 includes a user preference storage 74, an ad content storage 76, a program storage 78, and ad table storage 80. Although reference is made to the above being stored in mass storage device 72, it can be appreciated by one skilled in the art that such storages 74-80 can be included in any type of temporary or permanent memory or be utilized within functional modules adapted to store, provide access to, or perform functions associated with the user preferences, the ad content, the programming, and/or the ad table.

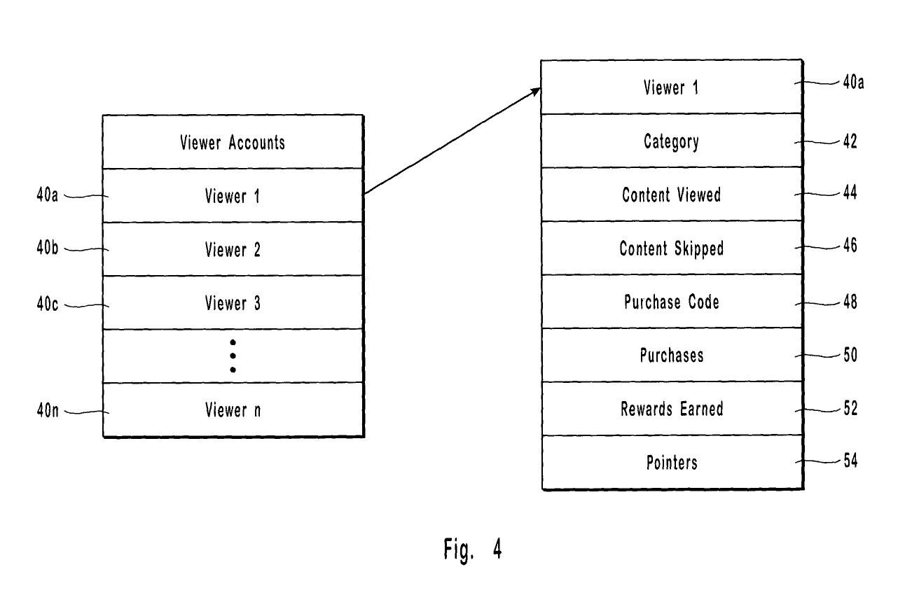

The user preference storage 74 stores information or data associated with the viewing preferences of one or more viewers using receiver module 16. These preferences, in one embodiment, are stored in viewer accounts, as illustrated in FIG. 4. Of the viewer accounts 40a-40n, one or more can be specific for specific viewers, while other viewer accounts can be generalize for a particular receiver module or group of receiver modules. For instance, one viewer account can include preferences for one member of a family who watches broadcast programming using the receiver module, while another viewer account can include preferences for another member of the same family. In this manner, the present invention enables multiple viewers of the same receiver module to define viewer specific viewing preferences, such as but not limited to, particular categories of advertising content to be displayed to each viewer of the receiver module. Alternatively, embodiments of the present invention can include one viewer account per receiver module. In still another embodiment, one viewer can select to define one or more viewer accounts, thereby allowing a parent to define particular viewing preferences for children and other viewer accounts for a one or both of the parents.

As illustrated, each viewer account 40a-40n includes attributes defining the viewing and purchasing characteristics of an individual viewer or group of viewers. As shown, a viewer account 40a includes an attribute defining the one or more categories of advertising content that a viewer wishes to watch, i.e., category attribute 42, the advertising content viewed by the viewer, i.e., content viewed attribute 44, and the advertising content skipped by the viewer, i.e., content skipped attribute 46. Additionally, each viewer account 40a-40n can include attributes that define a viewer's purchase code usable by the viewer to generate points or rewards, i.e., a purchase code attribute 48, products and services purchased by the viewer, i.e., purchases attribute 50, and points generated or rewards earned by the viewer, i.e., rewards earned attribute 52.

The category attribute 42 identifies the particular category of advertising content the viewer of receiver module 16 wishes to view. One or more categories can be stored within category attribute 42. These categories can include, but are not limited to, sports, entertainment, music, movies, comedy, purchasable goods or services, miscellaneous, or the like. By checking the category attribute 42 against available advertising content stored within receiver module 16 or received from operator module 12, receiver module 16 is able to identify which advertising content is to be displayed to a viewer.

Identification of the advertising content can be achieved by comparing the category information stored within the MPEG bitstream for the advertising content against the value of category attribute 42 to determine whether there is a match. When there is a match, the associated advertising content can be displayed to the viewer. This decision can be made upon a viewer selecting a particular button on the input device used to select viewer specific advertising content rather than view the currently displayed advertising content. Alternatively, the viewer can select specific advertising content preferences, which are used by processor 60 to automatically identify the advertising content of incoming advertising content specific to the viewer. For instance, processor 60 can compare the preferences against the data within an ad content table or the MPEG bitstream to identify matching advertising content. Consequently, the advertising content is tagged as being viewable by the specific viewer and references to such advertising content can be made with an attribute of the viewer account, such as pointer(s) 54.

Various other manners can be used to identify which advertising content is to be displayed for a specific viewer. For instance, in another configuration, each viewer account 40a-40n includes a copy of the advertising content that matches the particular category selected by the viewer.

The content viewed attribute 44 identifies the particular advertising content viewed by the viewer. The tracked content can be identified by the name of the advertising content displayed and viewed by the viewer, such as the name included in the MPEG bitstream, by the number of minutes, hours, etc of such advertising content viewed by the viewer, or the like.

In one embodiment, receiver module 16 tracks the start time and stop time of displayed advertising content and broadcast programming to calculate whether a first displayed advertising content was completely displayed to the viewer before the commencement of a second displayed advertising content or broadcast programming. For instance, the advertising content store in mass storage device 72 or received directly from operator module 12 includes one or more Society for Motion Picture and TV Engineer (SMPTE) codes that define the time, including hours, minutes, seconds, when the advertising content and/or the broadcast programming is displayed and terminated. By tracking these SMPTE codes and comparing the same against an internal clock within receiver module 16, receiver module 16 identifies when advertising content is viewed, skipped, fast forwarded, etc. In this manner, receiver module 16 calculates the amount of displayable advertising content watched by a viewer, the number of times the advertising content was viewed, whether advertising content was skipped or fast forwarded, etc. This information can be used to generate a number of rewards or points specific to the viewer, as will be discussed in greater detail hereinafter.

When there is a discrepancy between scheduled times, whether start or stop times, of the advertising content and/or broadcast programming and the actual display times, whether start or stop times for the advertising content and the broadcast programming, receiver module 16 stores such a discrepancy and generates a number of rewards or points corresponding to such an action. The number of points earned and the content viewed or skipped can be periodically, continuously, or sporadically uploaded to operator module 12 for storage and analysis.

The content skipped attribute 46 identifies the particular advertising content skipped by the viewer. This attribute 46 can be identified in a similar manner to that described with respect to content viewed attribute 44. The tracked content, therefore, can be identified by the name of the advertising content skipped by the viewer, such as the name included in the MPEG bitstream of the advertising content and/or by the category of the advertising content skipped.

The purchase code attribute 48 defines a viewer specific purchase code that the viewer can use to obtain discounts on products and services that the viewer purchases. This purchase code attribute 48 can be viewer specific and/or advertising content specific, i.e., different codes for different viewers and/or different advertising content. The purchase attribute 48 can be retrieved and delivered to receiver module 16 associated with the specific viewer when advertising content is delivered to receiver module 16. Alternatively, purchase attribute 48 can be a one-time attribute that is delivered to receiver module 16 for future use as the viewer purchases products and/or services following viewing advertising content. For instance, the purchase code can be displayed to the viewer together with advertising content.

The purchases attribute 50 defines which products or services were purchased subsequent to viewing the advertising content. Specifically, in the event that a viewer purchases products online, receiver module 16 and/or operator module 12 tracks which products are purchased by the viewer after viewing advertising content selected by the viewer. This can be achieved as an online seller, in one embodiment, continuously, periodically, sporadically, or upon request from receiver module 16 and/or operator module 12 delivers a list of those products or services associated with a viewer's purchase code. Thereafter, receiver module 16 and/or operator module 12 associates the purchases with the viewer and updates purchases attribute 50 and/or rewards earned attribute 52.

The rewards earned attribute 52 defines the number of reward, points, or “pool” of rewards or points earned by the viewer from watching broadcast programming and/or advertising content. These points or rewards can be used to offset the costs associated with watching broadcast programming, watching pay-per-view movies or events, or the like. Consequently, with the knowledge that by watching particular advertising content and/or broadcast programming the viewer can earn rewards or points, the viewer is incentivized to view such advertising content and/or broadcast programming.

Illustratively, a viewer can earn a certain number of rewards or points from watching advertising content, such as one or more points for watching one time slot of advertising content. Alternatively, the viewer can earn one or more rewards or points from watching advertising content for a particular period, such as minutes, hours, days, etc. For example, the viewer can earn one point for every minute of viewed advertising content. This is achieved by tracking the actions of a viewer in watching advertising content. For instance, receiver module 16 maintains a display time for each advertising content displayable to the viewer for a specific period, such as all advertising content to be displayed in one or more time slots, hours, days, weeks, etc. This display time acts as a running total of the quantity of advertising content watched by a viewer, with the maximum amount of time equaling the time associated with watching the advertising content from beginning to end one time. By maintaining the running total, receiver module 16 tracks the total time that a viewer spends watching the advertising content, whether the viewer (i) watches the advertising content one time, (ii) partially watches the advertising content at one time and watches the remainder of the advertising content at a later time, (iii) partially watches the advertising content and fast forwards or rewinds the advertising content a number of times, whether or not the viewer watches the complete advertising content from beginning to end, (iv) combinations thereof, or the like. When the maximum time is reached, receiver module 16 flags or tags the advertising content as being completely viewed, resulting in a defined number of points being added to the viewers rewards earned attribute. In this manner, receiver module 12 generates a number of rewards or points based upon the time taken to watch the advertising content, without the viewer generating excessive points from repeat watching of the advertising content through rewinding or fast forwarding the advertising content.

In another alternate configuration, receiver module 16 generates points based upon the number of times the advertising content is viewed. This is achieved by receiver module 16 tracking the number of times that the advertising content was “watched” by the viewer from beginning to end, without fast forwarding, whether or not the same instance of the advertising content is viewed a number of times.

In another configuration, viewers can earn points or rewards from purchasing a product or service, whether online or from a “brick and mortar” establishment, following viewing advertising content. For instance, in the event that a viewer selects to view advertising content associated with vehicles, and the viewer subsequently purchases a vehicle from a dealer that sells the vehicle advertised by the advertising content, the viewer receives a quantity of points or earned rewards for making such a purchase. By delivering the viewer's purchase code, which is retrieved from the purchase code attribute 48 and displayed to the viewer with the advertising content, the dealer, either online or through mailing or telephone correspondence, can notify the operator of operator module 12 of the sale. Thereafter, the operator can update the viewer's earned rewards and optionally notify the viewer of the availability of subsidies for viewing pay-per-view movies or events, subsidies for equipment rental or monthly fees, or the like.

One skilled in the art in light of the teaching contained herein can identify various other manners for tracking the purchase of products and receiving the appropriate rewards or points. For example, the viewer can receive in the mail from the operator of operator module 12, or the business entity sponsoring the advertising content that initiated the viewer's desire to purchase a product, a certificate that the viewer can present to a seller or other service provider indicating that the purchase has associated rewards, bonuses, discounts, or the like.

In addition to the above, receiver module 16 and/or operator module 12 is capable of tracking the usage of rewards or points earned through the viewer selecting to use a subsidy, receive free or reduced pay-per-view rates, special events rates, equipment rental, or the like. For instance, the viewer can receive notice of the availability of a subsidy from receiver module 16 and/or operator module 12 and receive data indicative of the viewer's selection to redeem one or more points or rewards for the subsidy, free or reduced rates, or the like. Illustratively, the viewer can be presented with a notification, such as a pop-up icon or graphical user interface, through which the viewer can select to redeem one or more points by depressing one or more buttons or keys associated with an input device or the like. Data indicative of such as a signal generated by depressing the button or key is delivered to receiver module 16 and consequently to operator module 12, thereby enabling operator module 12 to store a list of the subsidies associated with the viewer and deduct the appropriate number of rewards or points from the accumulated number of rewards or points.

As mentioned above, mass storage device 72 includes ad content storage 76. This ad content storage 76 stores advertising content received from operator module 12, such as advertising content specific to those categories of advertising content selected by the viewer, all available advertising content displayable to the viewer, whether or not the advertising content falls within one of the categories selected by the viewer, or the like. The advertising content can be stored in a variety of different formats, such as but not limited to, storing the advertising content in an alphabetical list per the name of the advertising content. Alternatively, the advertising content can be stored in a category list, where the advertising content for the same category are stored in the same or related file, field, record, or the like. In still another configuration, the advertising content is stored in calendar period groupings, i.e., days, weeks, months, or the like. For instance, the advertising content for one or more of the selected categories displayable during a particular day, week, month, or the like are stored together.

Mass storage device 72 can include program storage 78 that is configured to store electronic copies of the broadcast programming displayable to the viewer. For instance, program storage 78 can store copies of broadcast programming received from operator module 12, recorded copies of live or pre-recorded broadcast programming as requested by the viewer, combinations thereof, or the like. Consequently, program storage 78 and/or mass storage device 72 can be used to record data, in which case, receiver module 16 acts as a digital video recorder. The stored broadcast programming can be stored in a variety of formats, such as indexed lists of broadcast programming, alphabetical or data specific lists of broadcast programming, combinations thereof or the like.

Further, mass storage device 72 includes ad table storage 80 that stores ad content tables generated by and received from operator module 12. Receiver module 16 utilizes these stored ad content tables to identify when advertising content is to be displayed to the viewer, the specific MPEG stream used to deliver the advertising content to receiver module 16, category designation for each advertising content, combinations thereof or the like.

Mass storage device 72 is one structure capable of performing the function of a computer-readable media for carrying or having computer-executable instructions or data structures stored thereon. This computer-readable media can be any available media that can be accessed by a general purpose or special purpose computer. By way of example, and not limitation, such computer-readable media can comprise physical storage media such as RAM, ROM, EEPROM, CD-ROM or other optical disk storage, magnetic disk storage or other magnetic storage devices, or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to receiver module 16 or to operator module 12, both receiver module 16 and operator module 12 view the connection as a computer-readable medium. Thus, such a connection is also properly termed a computer-readable medium. Combinations of the above should also be included within the scope of computer-readable media.

It can be appreciated by one skilled in the art that operator module 12 can represent another structure capable of performing the function of a computer-readable media for carrying or having computer-executable instructions or data structures stored thereon. Further, the individual modules forming operator module 12 can represent other structures capable of performing the function of a computer-readable media for carrying or having computer-executable instructions or data structures stored thereon

As referenced above, receiver module 16 receives data from operator module 12. MPEG streams deliver the data to be stored within mass storage device 72 from operator module 12, periodically, sporadically, or continuously. The receiver module 16 tunes to the appropriate MPEG to retrieve the needed advertising content, ad content table, or broadcast programming. Illustratively, as shown in FIG. 3, receiver module 16 includes a signal receiver module 82 to perform such a function.

The signal receiver module 82 includes one or more tuners 92 capable of tuning to different MPEG streams received from operator module 12. For instance, when receiver module 16 includes a single tuner, this tuner can tune to one MPEG stream to receive broadcast programming, later tune to another MPEG stream to receive advertising content, and later tune to a third MPEG stream to receiver one or more ad content tables. When signal receiver module 82 includes multiple tuners, receiver module 16 can tune to multiple MPEG streams at the same time.

Further, signal receiver module 82 includes one or more signal decoders 90 optionally configured to (i) decipher the audio and/or video data representative of the broadcast programming and advertising content received from operator module 12 through tuners 92 and optionally convert the data from an analog format to digital format.

Optionally, signal receiver module 82 includes a modem 94 to enable receiver module 16 to access a wide area network, local area network, the Internet, etc using a communication line connection, such as but not limited to, a direct-dial communication over standard telephone lines, by using data transmission over the cable television infrastructure, a satellite network, an over-the-air broadcasting or any other available medium. Additionally, receiver module 16 can use modem 94 and an associated communication line connection to deliver data to operator module 12.

Further, signal receiver module 82 optionally includes an ad stripper module 96. This stripper module 96 functions in the same way as ad stripper module 36 of operator module 12. Consequently, ad stripper module 96 removes advertising content from broadcast programming received by receiver module 16. This advertising content can be displayed to the viewer and/or stored in ad content storage 76, while the broadcast programming can be displayed to the viewer and/or stored in program storage 78.

As illustrated, receiver module 16 communicates with a display device 100, such as a television display, a flat panel display, a projection display, a computer monitor, or any other device capable of displaying viewable image data, through a video output 102 and variety of different communication line connections known to those skilled in the art. Optionally, receiver module 16 and display device 100 can be integrally formed one with another. For example, wireless, radio frequency, S-video connection, a composite connection, or the like. Additionally, receiver module 16 can communicate with an audio system 104, such as one or more speakers for emitting sound data through an audio output 106 and/or a signal recorder 108, such as a video cassette recorder (“VCR”), capable of receiving video and/or audio data through video output 102 and audio output 106 and recording the data on a storage medium.

To enable a user to input information or user requests into receiver module 16, such as designating a particular programming channel or web page to view, receiver module 16 can include an input/output interface 110. This input/output interface 110 can receive instructions from an input device 112, such as a remote control, keyboard, microphone, joysticks, or any other device capable of generating instructions to control the operation of receiver module 16. Further, receiver module 16 can connect to other consumer electronic devices, such as video games, and/or various input devices.

In addition to the above, optionally, receiver module 16 can communicate with remote computers forming part of the Internet or some other wide area or local area network through modem 94, and the standard telephone lines. Optionally, other communication line connections can be used, such as but not limited to, Integrated Services Digital Network (ISDN) lines, cable lines associated with cable television service, wireless connection, satellite connection such as that described herein, or the like. Additionally, receiver module 16 can be configured to send and receive email, browse the World Wide Web (“Web”), access other segments of the Internet, and otherwise display information to a viewer via such communication line connections and associated hardware and/or software modules and components.

Illustratively, receiver module 16 can include the functionality associated with DVR or PVR technologies. For instance, receiver module 16 can be configured to or be capable of storing the available broadcast programming, advertising content, EPG data, or the like for an extended period of time, i.e., record the programming, content, data, or the like, and playback the same upon request by the viewer, such as upon the viewer utilizing input device 112 to request the playback of the recorded or stored broadcast programming, advertising content, EPG data, or the like. Additionally, or alternatively, receiver module 16 can store the broadcast programming and advertising content scheduled to be displayed during breaks in the broadcast programming and immediately display the broadcast programming and the advertising content following storing of the same on mass storage 72.

Receiver module 16, and more specifically processor 60, tracks the MPEG bitstreams received from operator module 12 to identify parameters and codes defining the broadcast programming and advertising content to be displayed to the viewer using receiver module 16 to tune to the particular MPEG bitstream. The manner to achieve this is known to those skilled in the art based upon the standards associated with MPEG encoding and decoding. In combination with the ad content table(s) stored in ad table storage 80, processor 60 can identify the advertising content included with broadcast programming received from operator module 16 and select to display the received advertising content or display advertising content receivable upon another MPEG stream or stored within ad content store 76. This can be achieved by comparing category information for all available advertising content, whether stored, received with the broadcast programming, or received upon another MPEG stream, with the viewer preferences within user preference storage 74 and displaying advertising content matching the viewer's preferences.

In another configuration, receiver module 16 searches for other types of identifiers or metadata associated with the broadcast programming and advertising content, such as identifiers or metadata in the “in-band,” “out-of-band,” or “vertical blanking line” portions of the broadcast programming and/or advertising content to determine when to display the programming or content. For example, receiver module 16 receives broadcast programming to be displayed on display device 78. Included in an “in-band” portion of the broadcast programming are the one or more identifiers or metadata that define when the broadcast programming is to be displayed to the viewer. In addition, the identifiers or metadata define when advertising content is to be displayed and display of the broadcast programming is terminated.

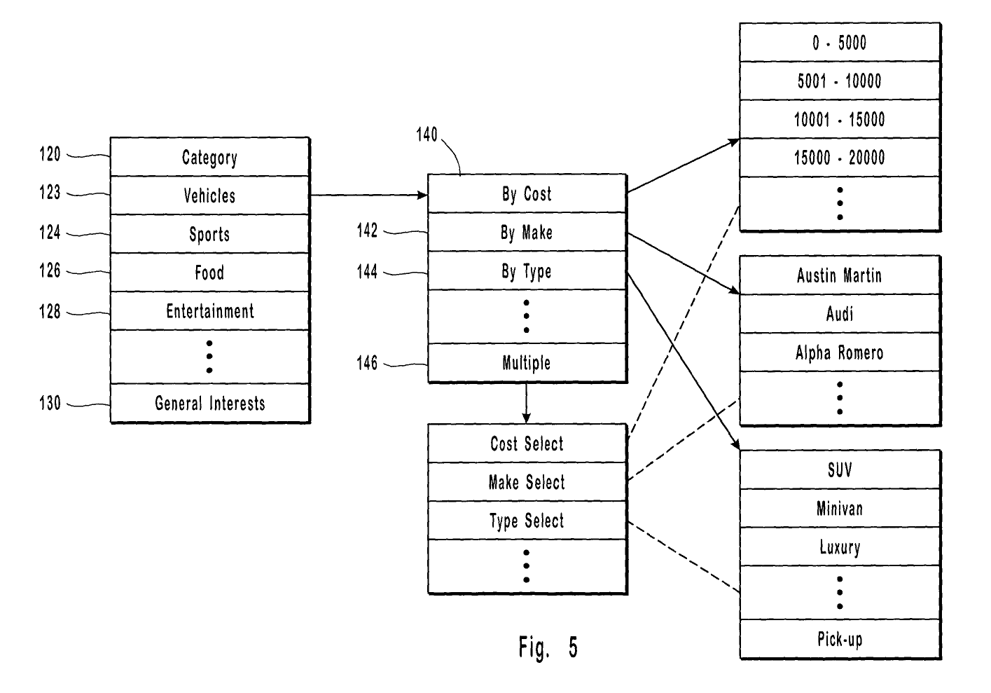

As shown in FIG. 5, depicted is a schematic representation of illustrative data that can be selected by the viewer to define the advertising content to be displayed to the viewer. The viewer can selected between multiple different categories 120 of advertising content to view, such as but not limited to, vehicles 122, sports 124, food 126, entertainment 128, general interest 130, or the like. Although the above-references categories are illustratively described, one skilled in the art can identify a variety of other categories that can be displayed to the viewer.

Each category 120 includes one or more sub-menus that enable the viewer to more specifically define the particular advertising content to be viewed. For instance, the viewer can select vehicles 122 and subsequently choose between vehicles based on a cost selection 140, a make selection 142, a type selection 144, multiple selections 146, or the like.

The cost selection 140 enables the viewer to select advertising content for vehicles within a specific cost range, such as but not limited to 0-$5,000, $5001-$10,000, $10,001-$15,000, $15,001-$20,000, or the like. The make selection 142 enables the viewer to select advertising content based upon the particular make of the vehicle, while the type selection enables the viewer to select advertising content based upon the type of car, i.e., sports utility vehicle, truck, minivan, luxury, or the like. The multiple selections 146 enables the viewer to be more specific regarding the advertising content based upon one or more of the other available choices. In this example, the viewer could select advertising content based upon cost and type, cost and make, type and make, or the like.

The selections made by the viewer are stored within receiver module 16. When receiver module 16 receives the advertising content from operator module 12, receiver module 16 searches the information contained within the MPEG bitstream to match the category of the advertising content with the selections of the viewer. Subsequently, receiver module 16 stores the advertising content specific to the viewer within a specific storage within receiver module 16 or references the advertising content as being one displayable to the viewer. For instance, a parent can define a child viewer account within receiver module 16 with a certain type of advertising content, while define a more mature level of advertising content to be displayed to the parent upon selection of the same by the parent through use of an input device, such as a remote control.

Alternatively, the selections made by the viewer can be transmitted to operator module 12. The operator module 12 updates stored viewer specific preferences and filters the advertising content delivered to receiver module 16 using these new preferences. For instance, before delivering advertising content to receiver module 16, operator module 12 can compare the stored category selections against the advertising content information. The advertising content that matches the category selected by the viewer are delivered to receiver module 16, while all other advertising content is stored at operator module 12.

No matter the manner by which the advertising content is selected, embodiments of the present invention facilitate display of the advertising content selected by the viewer rather than the advertising content typically displayed with the broadcast programming, i.e., the advertising content selected by the cable operator, satellite operator, networks, or the like.

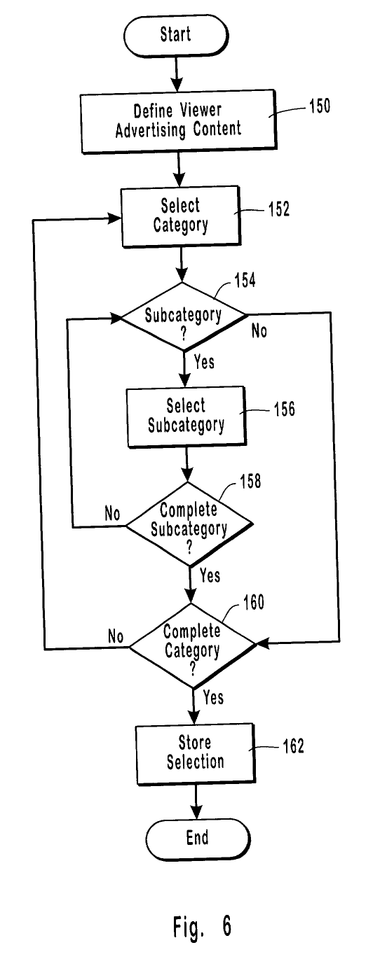

Referring now to FIG. 6, depicted is a flow diagram illustrating the manner by which a viewer selects a particular category of advertising content. As illustrated, a viewer can select to define one or more categories of advertising content to be substituted for advertising content that is scheduled to be displayed with broadcast programming, as represented by block 150. For instance, the viewer can push a button on user input device 112 (FIG. 3), select an icon displayed to the viewer, or the like to begin to define advertising content specific to a particular viewer.

Upon selecting to define one or more categories, the viewer can pick one or more categories of displayable advertising content, as represented by block 152. In the event that the selected category has one or more sub-categories, as represented by decision block 154 being in the affirmative, the viewer can pick one or more sub-categories associated with the category to more specifically define the advertising content to be displayed to the viewer, as represented by block 156. The process of picking categories and/or sub-categories continues until the viewer selects all categories and sub-categories associated with the viewer's interests, as represented by decision blocks 158 and 160 being in the affirmative.

Once all categories and subcategories are selected, data representative of the picked categories and subcategories is stored in receiver module 16 and optionally delivered to operator module 12, as represented by block 162. In this manner, the viewer's selections are stored at receiver module 16 and optionally at operator module 12, allowing receiver module 16 and optionally operator module 12 to filter advertising content displayed to specific viewers.

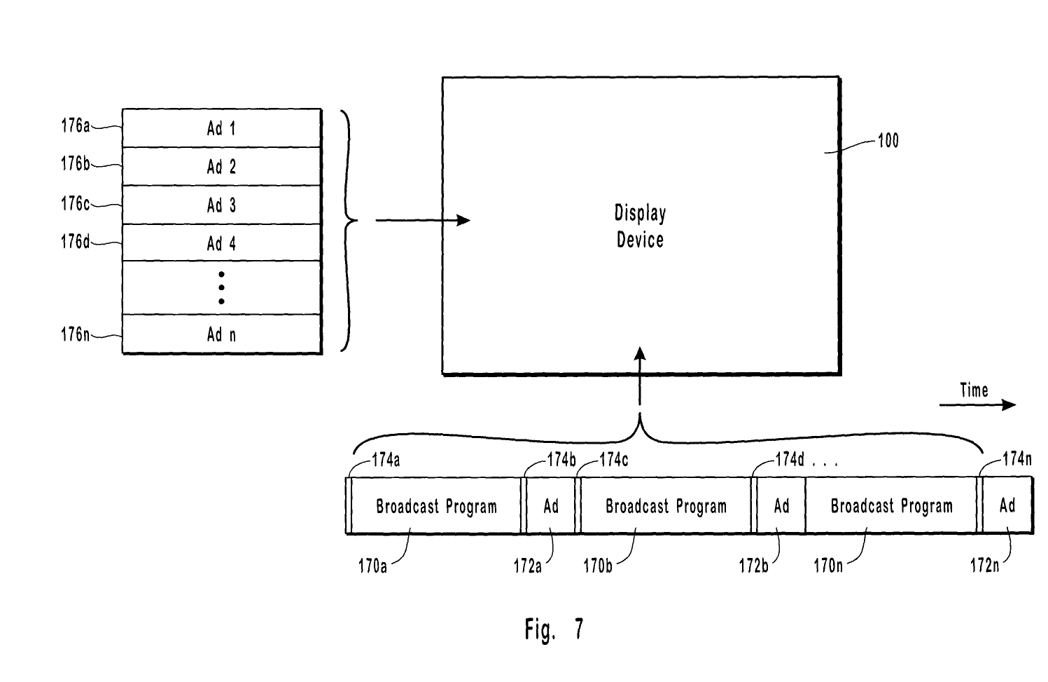

With respect to FIG. 7, a schematic representation of one illustrative manner by which the advertising content selected by the viewer is displayed instead of the advertising content typically associated with the broadcast programming. The receiver module 16 tunes to a particular MPEG stream of broadcast programming, including associated advertising content, based upon selection made by the viewer. The broadcast programming is displayed to the viewer through display device 100, optionally without storing the broadcast programming on mass storage device 72 (FIG. 3). Alternatively, the broadcast programming is stored within mass storage device 72.

The following discussion will be directed to a receiver module that is capable of storing viewer specific advertising content upon mass storage device 72 (FIG. 3), while broadcast programming and advertising content scheduled for display in association with the broadcast programming is directly displayed to the viewer. Further, the following discussion will be directed to the receiver module that substitutes viewer specific advertising content for the advertising content scheduled to be displayed with the broadcast programming. Although this is the case, a similar discussion can be made for other embodiments where broadcast programming, advertising content deliverable with the broadcast programming, and/or viewer specific advertising content is stored upon a mass storage device and retrievable by the receiver module in accordance with data stored within an ad content table, data included in the MPEG bitstream delivering the advertising content and/or the broadcast programming, based upon inputs received by the receiver module from the viewer, or the like.

As shown, the receiver module displays broadcast programming 170a -170n and associated advertising content 172a-172n on display device 100, whether or not such programming 170a-170n and/or advertising content 172a-172n was previously stored on mass storage device 72 for a short or long period of time. One or more identifiers, metadata, or other data included in the MPEG bitstream delivering the advertising content and/or broadcast programming 174a-174n defines the transitions between broadcast programming 170a-170n and advertising content 172a-172n. Alternatively, the data stored within an ad content table defines the times when the advertising content is to be displayed, thereby defining the terminating times of the broadcast programming. The data, whether identifiers, metadata, other data, or data within the ad content table define when broadcast programming 170a-170n is to cease and advertising content 172a-172n is to commence; or vice versa. The receiver module searches for such data as broadcast programming 170a -170n and advertising content 172a-172n is displayed to the viewer. When the receiver module identifies the end of broadcast programming 170a-170n, the receiver module compares the category information associated with advertising content 172a-172n against the category selections made by the viewer, i.e., category attribute 42 stored at the receiver module. When advertising content 172a-172n matches category attribute 42, the receiver module need not substitute the advertising content with advertising content 176a -176n. In the event that no match occurs, the receiver module retrieves advertising content 176a -176n specific for the viewer from a separate store of advertising content within the receiver module and displays the same to the viewer.

In another embodiment, a viewer can initiate a change in the advertising content being displayed on display device 100. For instance, when advertising content 172a-172n is displayed, a viewer can use input device 112 (FIG. 3) to switch the displayed advertising content to advertising content 176a-176n. Illustratively, this can be achieved upon the receiver module receiving a signal or data indicative of the viewer depressing a button on input device 112 (FIG. 3) to initiate the change from advertising content 172 a-172n to advertising content 1 76a- 176n, such as a skip-ad button. When the receiver module receives the signal, the receiver module automatically terminates displaying the current advertising content and retrieves the advertising content specific to the viewer, as defined by reference numeral 176a-176n, to display the same to the viewer. Alternatively, the receiver module can deliver a prompt to the viewer that enables the viewer to select advertising content specific to the viewer that is stored in a mass storage at the receiver module or at the operator module. Further, by selecting the skip-ad button once the viewer specific operator content is displayed to the viewer, the viewer specific advertising content is skipped.

In another embodiment of the present invention, the receiver module is configured to present broadcast programming and/or advertising content that is stored on a mass storage at the receiver module to the viewer. For instance, in a DVR or PVR environment the broadcast programming, the scheduled advertising content to be displayed with the broadcast programming, and the advertising content that can be substituted for the scheduled advertising content, i.e., the viewer specific advertising content, are stored on a mass storage, such as mass storage 72 (FIG. 3), for either a short or long period of time, as described herein, before the programming or content is shown to the viewer. In such a case, the display of broadcast programming and advertising content, whether scheduled or viewer specific advertising content, is displayed to the viewer in accordance with selections made by the viewer using input device 112 (FIG. 4).

According to another aspect of the present invention, the receiver module can selectively change which advertising content is to be displayed to the viewer. In some circumstances, the receiver module is incapable of changing certain advertising content from advertising content 172a-172n to advertising content 176a-176 n. For instance, certain Network, cable provider, or satellite provider advertisements will substantially always be shown to the viewer. This advertising content includes data, such as stored in the ad content table and/or received in the MPEG bitstream carrying the advertising content, which notifies the receiver module that such advertising content is to be displayed to the viewer even if the category is different from those chosen by the viewer.

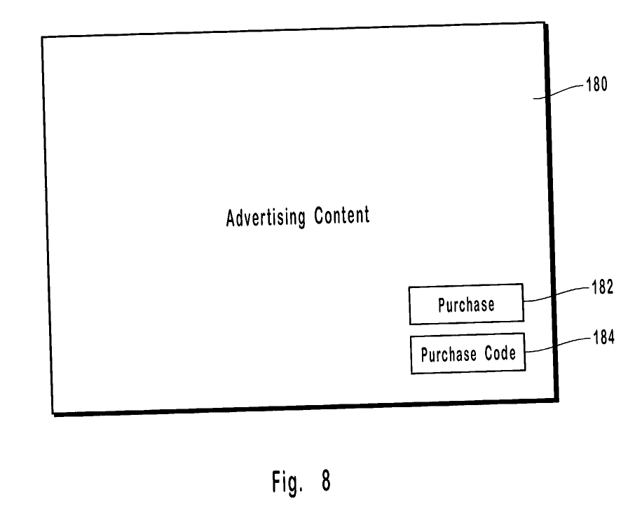

According to another aspect of the present invention, a viewer is enabled to purchase products or services that are displayed on a display device. With respect to FIG. 8, a display device displays advertising content 180 to a viewer. Optionally simultaneously with displaying advertising content 180, the receiver module displays a purchase button 182 and a purchase code 184. Alternatively, purchase button 182 and/or purchase code 184 are displayed following display of the advertising content.

Purchase button 182 can be a clickable button when the receiver module includes a mouse or other pointer type functionality. Alternatively, purchase button 182 can be a button actuated upon depressing an associated button on input device 112 (FIG. 3).

Upon selecting button 182, the receiver module switches from displaying advertising content to the viewer to accessing a web site or web page related with the product or service advertised through advertising content. In this manner, the viewer is provided with access to the specific web site or web page through which the viewer can purchase the product or services. Upon entering purchase code 184 at the appropriate time during purchase of the product or service, the viewer obtains discounts, concessions, or benefits specific to purchases made following viewing the advertising content. Alternatively, to facilitate purchasing of the product or services, the receiver module can deliver purchase code 184 to the web site along a secure connection, such as through Secure Sockets Layer (SSL), Secure HyperText Transport Protocol (SHTTP), or the like to limit the need for the viewer to input or remember purchase code 184.

According to another embodiment, the viewer can use the purchase code during direct communication with the provider of the product or service, such as at a “brick and mortar” establishment, through telephone, facsimile, or electronic mail message communication, or the like at a later time to obtain appropriate discounts, concessions, or benefits for advertised products or services.

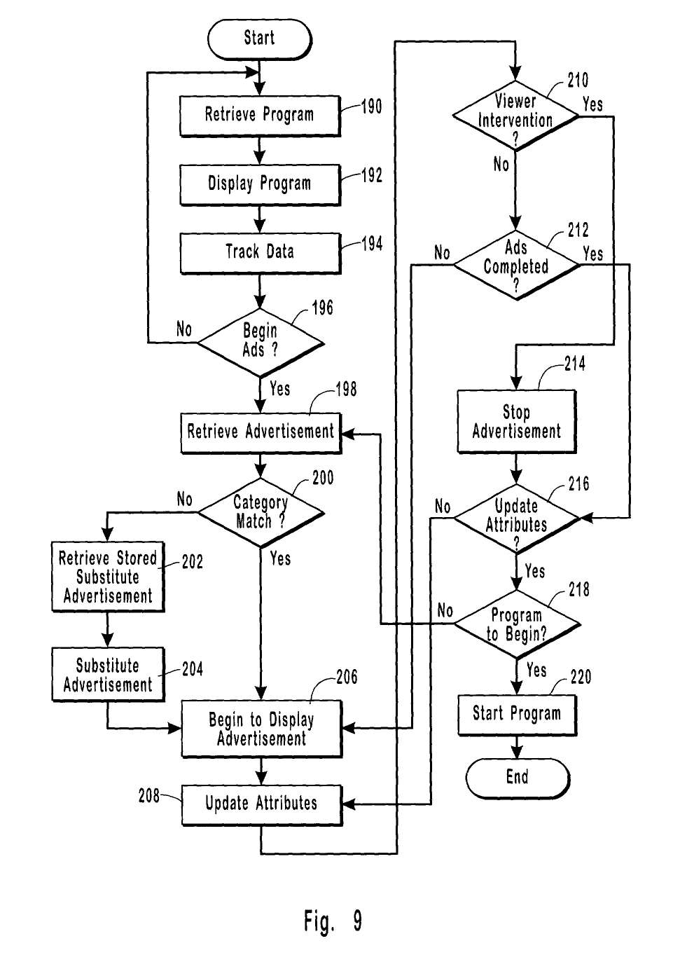

Referring now to FIG. 9, depicted is a flow diagram illustrating the manner by which a receiver module displays the advertising content to the viewer. Initially, the receiver module receives broadcast programming from the operator module as represented by block 190. Upon receiving the broadcast programming, the receiver module displays the broadcast programming, as represented by block 192. For example, the broadcast programming can be displayed to a viewer upon a display device, such as a television, monitor, cathode ray tube, high definition screen, or the like.

As the broadcast programming is displayed to the viewer, the receiver module tracks data within the MPEG bitstream of the broadcast programming, as represented by block 194. The data identifies when the broadcast programming is to start, stop, pause, or the like. Consequently, the receiver module can track when to begin to display advertising content, as represented by decision block 206. The receiver module continues to display the broadcast programming until an appropriate data instructs or initiates the receiver module to display advertising content.

When the receiver is to display the advertising content, the receiver module retrieves the advertising content, as represented by block 198. This can be achieved by accessing the advertising content delivered to the receiver module with the broadcast programming. Alternatively, this can be achieved by accessing stored advertising content associated with the broadcast programming that was previously delivered to the receiver module.

In either case, the receiver module compares the advertising content data, whether in the MPEG bitstream for the first case or the ad content table for the second case, against the category information selected by the viewer to determine whether there is a category match, as represented by decision block 200. More specifically, in one embodiment, the receiver module compares the advertising content data against the category attribute within the viewer's account. Although reference is made to comparing advertising content data in the MPEG bitstream when the advertising content is delivered with the broadcast programming, it can be understood that the receiver module can access the advertising content data within the ad content table for the advertising content delivered with the broadcast programming.

When the retrieved advertising content matches the category, the receiver module displays the advertising content to the viewer, as represented by block 206. In the alternative, when the retrieved advertising content and the category attribute do not match, i.e., decision block 200 is negative, the receiver module accesses stored advertising content that matches the selected category attribute, as represented by block 202. Subsequently, this retrieved advertising content is substituted for the previously retrieved advertising content, as represented by block 204 and displayed to the viewer, as represented by block 206.

Upon displaying the advertising content to the viewer, the attributes stored within the viewer's account are updated, as represented by block 208. Accordingly, the content viewed attribute, the rewards earned attribute, and other attributes are updated to indicate that the viewer is watching selected advertising content.

While the advertising content is displayed to the viewer, the receiver module tracks the amount of the video content presented to the viewer, the amount of video content remaining to be displayed, any viewer interaction performed by the viewer, or the like. The advertising content is displayed to the viewer until either the advertising content is completely displayed to the viewer or the viewer performs an action to cease or terminate the display of the advertising content.

In the event that a viewer performs an action to terminate or skip the advertising content, such as a request to skip displayed advertising content through use of the input device, i.e., a skip-ad button, as represented by decision block 210 in the affirmative, the receiver module receives a signal from the input device, processes the signal, and terminates or stops the display of the displayed advertising content, as represented by block 214. Consequently, the receiver module checks whether the viewer specific attributes have been updated to indicate that the advertising content is to be skipped, as represented by decision block 216. When this is in the negative, the receiver module updates the viewer attributes.

When the viewer attributes have been updated, the receiver module determines whether broadcast programming is to be displayed to the viewer, as represented by decision block 218. In the event that the broadcast programming is available, the receiver module displays the broadcast programming to the viewer, as represented by block 220. When no broadcast programming is to be displayed, the receiver module selects available advertising content, whether stored within the receiver module or deliverable to the receiver module in an MPEG stream associated with the broadcast programming, as represented by the line extending from decision block 218 toward block 198.

Returning to decision block 210, in the event that no viewer interaction occurs, i.e., decision block 210 is in the negative, the receiver module tracks to identify whether the advertising content has been completely displayed to the viewer, as represented by decision block 212. When decision block 212 is in the negative, the receiver module continues to display the advertising content and tracks for viewer interactions. Further, the receiver module updates the stored viewer attributes within the viewer's account.

In the event that the advertising content has been completely displayed, as represented by decision block 212 being in the affirmative, the viewer attributes are updated and subsequently other advertising content or broadcast programming is displayed to the viewer.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. In a system that includes a display device on which broadcast programming and advertising content can be displayed, a method for generating rewards for viewing advertising content, the method comprising:
receiving advertising content to be displayed to the viewer, the advertising content comprising data defining a category of the advertising content; accessing a viewer account to determine which advertising content is to be displayed to the viewer, the viewer account comprising at least one of a category attribute and a rewards earned attribute; and
upon displaying the advertising content with the data that matches the category attribute of the viewer account, updating the rewards earned attribute to reflect the portion of the adverting content viewed by the viewer.

2. The method as recited in claim 1, further comprising storing, at a receiver module, advertising content having the category identifier matching the category attribute of the viewer account.

3. The method as recited in claim 1, further comprising tracking display of the advertising content to identify when the viewer selects to terminate the display of the advertising content.

4. The method as recited in claim 3, further comprising upon identifying the amount of the advertising content displayed to the viewer before the viewer selects to terminate the display of the advertising content, updating the rewards earned attribute with a number of rewards earned associated with the amount of the advertising content displayed to the viewer.

5. The method as recited in claim 1, further comprising, identifying when the advertising content is completely displayed to the viewer.

6. The method as recited in claim 5, further comprising, upon identifying the amount of the advertising content displayed to the viewer, updating the rewards earned attribute to indicate that the advertising content was completely displayed to the viewer.

7. The method as recited in claim 1, further comprising notifying the viewer of the availability of one or more subsidies, the one or more subsidies being based upon the quantity of rewards defined by the rewards earned attribute.

8. In a system that includes a display device on which broadcast programming and advertising content can be displayed, a method for displaying viewer specific advertising to a viewer, the method comprising:
storing, at a receiver module, a category attribute defining one or more categories of advertising content to be displayed to the viewer upon the display device and a reward earned attribute defining the number of rewards earned by the viewer;
receiving advertising content to be displayed to the viewer with the broadcast programming, the advertising content comprising category data defining a category of the advertising content; and
upon comparing the category attribute against the category data for the advertising content, displaying the advertising content when the category data matches the category attribute and updating the rewards earned attribute to reflect the amount of the advertising content viewed by the viewer.

9. The method as recited in claim 8, further comprising storing at at least one of the receiver module and an operator module, in communication with the receiver module, an ad content table, the ad content table defining category data for the advertising content.

10. The method as recited in claim 8, further comprising storing, at at least one of the receiver module and an operator module, in communication with the receiver module, advertising content having the category data matching the category attribute.

11. The method as recited in claim 10, further comprising identifying when a viewer terminates the display of the advertising content

12. The method as recited in claim 11, further comprising, upon the viewer terminating the display of the advertising content, updating the rewards earned attribute associated with the viewer.

13. The method as recited in claim 8, wherein the receiver module comprises one or more viewer accounts, each of the one or more viewer accounts comprising the category attribute, the rewards earned attribute, a purchase attribute, a content skipped attribute, and a content viewed attribute.

14. The method as recited in claim 8, wherein the broadcast programming comprises data defining at least one of a start time, a stop time, a time remaining, and a time displayed.

15. The method as recited in claim 8, further comprising when no match occurs between the category data and the category attribute, retrieving advertising content stored at the receiver module having category data matching the category attribute.

16. The method as recited in claim 8, further comprising displaying a purchase code associated with the advertising content to the viewer.

17. The method as recited in claim 16, wherein the purchase code is specific to the viewer.

18. The method as recited in claim 16, further comprising displaying a purchase icon to the viewer, the purchase icon facilitating purchase of a product or a service promoted by the advertising content.

19. A computer program product for implementing, in system having at least one receiver module that has at least one processor and is capable of receiving broadcast programming and advertising content, a method for displaying advertising content to a viewer, the computer program product comprising:
a computer readable medium carrying computer-executable instructions for implementing the method, wherein the computer-executable instructions, when executed by the processor, cause the system to perform the acts of:
storing, at a receiver module, advertising content specific for the viewer and a category attribute defining one or more categories of advertising content to be displayed to the viewer upon the display device;
receiving other advertising content and broadcast programming to be displayed to the viewer, the other advertising content comprising category data defining a category of the other advertising content; and
upon comparing the category attribute against the category data, retrieving the advertising content specific for the viewer and substituting the advertising content specific for the viewer when the category data of the other advertising content is different from the category attribute.

20. The computer program product as recited in claim 19, wherein the computer-executable instructions, when executed by the processor, further cause the system to perform the act of identifying the amount of the advertising content displayed to the viewer before the viewer selects to terminate display of the advertising content.

21. The computer program product as recited in claim 20, wherein the computer-executable instructions, when executed by the processor, further cause the system to perform the act of, upon identifying the amount of the advertising content displayed to the viewer, updating a rewards earned attribute stored at the receiver module.

22. The computer program product as recited in claim 19, wherein the computer-executable instructions, when executed by the processor, further cause the system to perform the act of identifying when the advertising content is completely displayed to the viewer.

23. The computer program product as recited in claim 19, wherein the receiver module comprises one or more viewer accounts, each of the one or more viewer accounts comprising the category attribute and a rewards earned attribute.

24. The computer program product as recited in claim 23, wherein the computer-executable instructions, when executed by the processor, further cause the system to perform the act of, upon receiver module completely displaying the advertising content to the viewer, updating the rewards earned attribute.

25. The computer program product as recited in claim 24, wherein the computer-executable instructions, when executed by the processor, further cause the system to perform the act of identifying when to display the advertising content.

26. The computer program product as recited in claim 25, wherein the computer-executable instructions, when executed by the processor, further cause the system to perform the act of accessing an ad content table to identify when to display the advertising content.

27. The computer program product as recited in claim 24, wherein the computer executable instructions, when executed by the processor, further cause the system to perform the act of notifying the viewer of the availability of one or more subsidies, the one or more subsidies being based upon the quantity of rewards defined by the rewards earned attribute.

28. The computer program product as recited in claim 19, wherein the broadcast programming comprises data defining at least one of a start time, a stop time, a time remaining, and a time displayed.

29. In a system that includes a display device on which broadcast programming and advertising content can be displayed, a method for displaying advertising content to a viewer, the method comprising:
storing, at a receiver module, an ad content table defining category data for each of a plurality of available advertising content displayable upon the display device and a category attribute specific to the viewer and a rewards earned attribute defining the number of reward earned by the viewer;
upon receiving the plurality of advertising content, storing the plurality of advertising content; and
upon comparing the category attribute against the category data, displaying advertising content, having the category data matching the category attribute, upon the display device and updating the reward earned attribute to reflect the amount of the advertising content viewed by the viewer.

30. The method as recited in claim 29, further comprising receiving data indicating when the viewer selects to terminate the display of the advertising content.

31. The method as recited in claim 31, further comprising updating the rewards earned attribute upon identifying an amount of the advertising content displayed to the viewer.

32. The method as recited in claim 29, further comprising identifying when the advertising content is completely displayed to the viewer.

33. The method as recited in claim 29, further comprising displaying a purchase code to the viewer.

34. The method as recited in claim 33, further comprising identifying when the viewer purchases a good or service associated with the advertising content displayed to the viewer using the purchase code.

35. The method as recited in claim 34, further comprising updating the rewards earned attribute based upon the good or service purchased.

36. The method as recited in claim 33, wherein the purchase code is unique for each of the advertising content delivered to the viewer.

37. The method as recited in claim 33, wherein the purchase code is the same for all advertising content displayed to the viewer.

38. The method as recited in claim 37, further comprising, upon the viewer selecting to purchase a good or service associated with the advertising content, delivering the purchase code to the provider of the good or service.

39. The method as recited in claim 38, further comprising updating the rewards earned attribute based upon the good or service purchased.

40. In a system that includes a processor and a display device on which broadcast programming can be displayed, a method for substituting advertising content associated with broadcast programming with advertising content associated with a viewer selected category, the method comprising:
a step for defining one or more attributes specific for the viewer of the display device, the one or more attributes comprising at least one of a category attribute, a purchase code attribute, and a rewards earned attribute;
a step for receiving a plurality of advertising content from an operator module, each of the plurality of advertising content comprising an identifier that matches the category attribute;
a step for receiving a plurality of general advertising content from the operator module, at least one of the plurality of general advertising content comprising a general identifier; and
upon comparing the category attribute against the general identifier, a step for retrieving one of the plurality of advertising content and substituting and displaying the one of the plurality of advertising content for one of the plurality of general advertising content when the general identifier is different from the category attribute.

41. In a system that includes a display device on which broadcast programming and advertising content can be displayed, a method for generating rewards for viewing advertising content, the method comprising:
storing one or more viewer attributes unique to the viewer, the one or more viewer attributes comprising:
a category attribute defining one or more categories of advertising content to be displayed to the viewer upon the display device; and
a rewards earned attribute defining the quantity of rewards earned from viewing advertising content;
receiving advertising content to be displayed to the viewer, the advertising content comprising a category identifier defining a category of the advertising content;
upon comparing the category attribute against the category identifier, displaying advertising content for which the category identifier matches the category attribute; and
upon displaying the advertising content to the viewer, updating the rewards earned attribute to include rewards associated with the length of time that the viewer viewed advertising content.
